(19) United States
(12) Patent Application Publication
(10) Pub. No.: US 2008/0037417 A1
(43) Pub. Date: Feb. 14, 2008

(54) Duplex system for setting route of telecommand and method thereof

(76) Inventors: Tae-Hee Kim, Daejon (KR); Jeom-Hun Lee, Daejon (KR); Jae-Hoon Kim, Daejon (KR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/644,528

(22) Filed: Dec. 22, 2006

(30) Foreign Application Priority Data
Aug. 8, 2006 (KR) 10-2006-0074931

(51) Int. Cl. H04J 3/14

(52) U.S. Cl. 370/217

(57) ABSTRACT

The present invention provides a duplex system for setting a route of telecommand and a method thereof. A duplex system for setting a route of telecommand, including: a first telecommand processing unit and a second telecommand processing unit for changing a format of a telecommand into a predetermined format; an up/down converting unit for up-converting the telecommand and for down-converting a telemetry; a first modem for modulating the telecommand; a second modem for modulating the telecommand; a control unit for setting the first modem as the route of telecommand, observing the first modem and the second modem and changing the second modem as the route of telecommand when an error occurs in the first modem; and a switching unit for setting the route of telecommand as one of the first modem and the second modem and transmitting the telecommand into the up/down converting unit.

### FIELD OF THE INVENTION

The present invention relates to a duplex system for setting a route of telecommand and a method thereof; and, more particularly, to a duplex system for setting a route of telecommand and a method thereof, which setup a backup modem as the route of the telecommand within a re-transmission time of the telecommand when an error is detected in a primary modem during transmission of the telecommand into a satellite in a satellite control system.

### DESCRIPTION OF RELATED ART

Generally, a satellite control system performs a satellite control by transmitting a telecommand into a satellite and receiving a telemetry from the satellite.

Especially, the satellite control system should be secured a stability and a reliability when the satellite control system transmits the telecommand into the satellite. That is, when the satellite control system transmits the telecommand into the satellite abnormally, a critical error to the satellite is caused, to thereby a wanted operation cannot be performed.

As described above, the satellite control system sets a one route for transmitting the telecommand to the satellite. When the satellite control system determines the route of telecommand, the satellite control system transmits the telecommand through only the predetermined route due to characteristics and applications of the satellite that the satellite cannot receive a plurality of telecommands at the same time.

Also, the satellite control system conforms telecommand format of a consultative committee for space data systems (CCSDS), an international standard for controlling the satellite, and transmits the telecommand to the satellite with securing a frame sequence by using a command operation procedure (COP) recommended in the CCSDS. In addition, the satellite control system secures a sequence of telecommands by examining a command link control word (CLCW) of the telemetry for a corresponding telecommand transmitted to the satellite and re-transmitting the telecommand when the telecommand is transmitted abnormally.

The conventional satellite control system should reset the route of telecommand by using an extra apparatus when errors occur in an apparatus for transmitting the telecommand, e.g., a telecommand transmitting modem. Herewith, complication of operations and a time delay for resetting the route of telecommand occur in the conventional satellite control system. This inhibits operations of the satellite which performs an execution of telecommand within a predetermined time.

Therefore, the conventional satellite control system is needed to transmit the telecommand without resetting the new route of telecommand in order to secure the stability and the reliability of transmitting the telecommand when errors occur in the predetermined route of telecommand.

### SUMMARY OF THE INVENTION

It is, therefore, an object of the present invention to provide a duplex system for setting a route of telecommand and a method thereof, which setup a backup modem as the route of the telecommand within a re-transmission time of the telecommand when an error is detected in a primary modem during transmission of the telecommand into a satellite in a satellite control system.

In accordance with an aspect of the present invention, there is provided a duplex system for setting a route of telecommand, including: a first telecommand processing unit and a second telecommand processing unit for changing a format of a telecommand into a predetermined format; an up/down converting unit for up-converting the telecommand and for down-converting a telemetry; a first modem for modulating the telecommand inputted from the first telecommand processing unit, and transmitting a first modulated telecommand; a second modem for modulating the telecommand inputted from the second telecommand processing unit, and transmitting a second modulated telecommand; a control unit for setting the first modem as the route of telecommand, observing the first modem and the second modem and changing the second modem as the route of telecommand when an error occurs in the first modem; and a switching unit for setting the route of telecommand as one of the first modem and the second modem based on a control command from the control unit and transmitting the telecommand through the route the telecommand into the up/down converting unit.

In accordance with another aspect of the present invention, there is provided a method for setting a route of telecommand, including the steps of: a) when a first route is determined as the route of telecommand between the first route and a second route, observing states of the first route and the second route; and b) when an error occurs in the first route and the second route is normal, detecting the error in the first route and changing the route of telecommand from the first route to the second route within a transmission period of the telecommand.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a diagram for illustrating a satellite control system in accordance with an embodiment of the present invention;

FIG. 2 is a diagram for illustrating a method for setting a route of telecommand in a duplex system in accordance with an embodiment of the present invention;

FIG. 3 is a diagram for illustrating a signal flow for resetting a route of telecommand into a backup modem by detecting an error in a primary modem in accordance with an embodiment of the present invention; and

FIG. 4 is a flowchart for illustrating a method for setting a route of telecommand in accordance with an embodiment of the present invention.

### DETAILED DESCRIPTION OF THE INVENTION

Hereinafter, a duplex system for setting a route of telecommand and a method thereof in accordance with an embodiment of the present invention will be described in more detail with reference to the accompanying drawings.

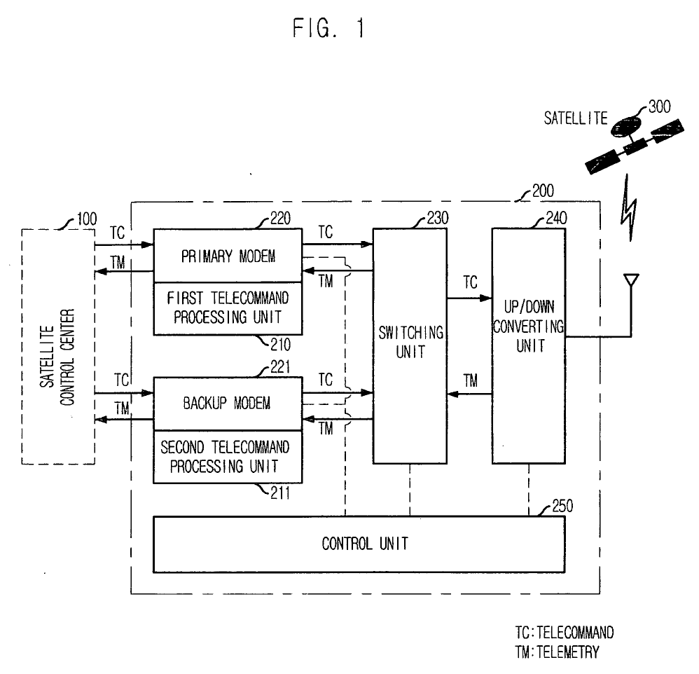

FIG. 1 is a diagram for illustrating a satellite control system in accordance with an embodiment of the present invention.

As shown, the satellite control system includes a satellite control center 100, a duplex system 200 and a satellite 300.

The satellite 300 is a low earth orbit satellite which is easily apprehended to those skilled in the art, for easy description, detailed description on the satellite will be omitted.

The satellite control center 100 generates a telecommand transmitted into the satellite 300 through the duplex system 200 and processes a telemetry received from the satellite 300 through the duplex system 200. The satellite control center 100 performs below functions for generating the telecommand and transmitting the telecommand into the satellite 300.

First, the satellite control center 100 initializes the duplex system 200 before transmitting the telecommand into the satellite 300. That is, the satellite control center 100 performs a connection setting of a transport control protocol/internet protocol (TCP/IP), i.e., setting a private port, with the duplex system 200 and a setting of COP configuration information.

In other words, the satellite control center 100 determines the private port for transmitting the telecommand and receiving the telemetry and communicates with the duplex system 200 through the predetermined private port. At this time, the satellite control center 100 sets TCP/IP connections among a first telecommand processing unit 210, a second telecommand processing unit 211, a primary modem 220 and a backup modem 221 of the duplex system 200 which will be described later.

Also, the satellite control center 100 sets the COP configuration information, to thereby secure a frame sequence of the telecommand transmitted into the satellite 300 through the duplex system 200. At this time, the satellite control center 100 sets parameters of the COP configuration information applied in the duplex system 200 based on telecommand format of the international standard CCSDS. The parameters of the COP configuration information include “FOP_Sliding_Window_Width”, “V(s) to V*(S)”, “T1_Initial”, Transmission_Limit”, and “Timeout_Type”. The parameters are apparent to those skilled in the art, therefore, for easy description, detailed description will be omitted.

In addition, the satellite control center 100 transmits commands for unifying the frame number of the telecommand and the frame number of telecommand to be received in the satellite 300 later, into the satellite 300 through the duplex system 200 before transmitting the telecommand into the satellite 300.

Next, the satellite control center 100 checks the transmission state of the telecommand transmitted into the duplex system 200 and the transmission state of the telecommand transmitted into the satellite 300.

The satellite control center 100 applies the COP algorithm to the telecommand, transmits the telecommand into the duplex system 200 and receives a response message of the telecommand from the duplex system 200. The satellite control center 100 confirms the transmission state of the telecommand when the response message is received normally. Also, the satellite control center 100 re-transmits the same telecommand into the duplex system 200 when the response message is received abnormally.

As described above, the satellite control center 100 confirms that the transmission state of the telecommand transmitted into the satellite 300 is normal when the response message is received from the duplex system 200 normally.

More particularly, the satellite control center 100 receives a corresponding message from the duplex system 200 according to telecommand reception results, i.e., normal reception and abnormal reception, of the satellite 300 confirmed in the duplex system 200. That is, the satellite control center 100 receives the corresponding message “Positive Confirm” from the duplex system 200 when the satellite 300 receives the telecommand normally. And, the satellite control center 100 receives the corresponding message “Negative Confirm” and “Suspend Indication” or “Alert Indication” from the duplex system 200 when the satellite 300 receives the telecommand abnormally. Herein, “Suspend Indication” is a message based on the parameter “Timeout_Type” of the COP configuration information.

Especially, when the satellite control center 100 receives the “Suspend Indication” message from the duplex system 200, the satellite control center 100 performs functions based on the commands from an operator. At this time, when the operator requests the satellite control center 100 to transmit the telecommand continuously, the satellite control center 100 requests the duplex system 200 to transmit the suspended telecommand continuously. Also, when the operator requests the satellite control center 100 to suspend transmitting the telecommand, the satellite control center 100 suspends transmission of the telecommand.

Moreover, when the satellite control center 100 receives the “Alert Indication” message from the duplex system 200, the satellite control center 100 suspends transmission of the telecommand by confirming the corresponding message.

The duplex system 200 transmits the telecommand received from the satellite control center 100 into the satellite 300 stably and transmits the telemetry received from the satellite 300 into the satellite control center 100. Since the duplex system 200 duplicates the route of telecommand, the telecommand can be stably transmitted from the satellite control center 100 to the satellite 300.

Below, the duplex system 200 will be described in detail.

As shown in FIG. 1, the duplex system 200 in accordance with the present invention includes the first telecommand processing unit 210, the second telecommand processing unit 211, the primary modem 220, the backup modem 221, a switching unit 230, an up/down frequency converting unit 240 and a control unit 250.

The primary modem 220 is a modem set as a ‘primary modem mode’ and the backup modem 221 is a modem set as a ‘backup modem mode’. The primary modem 220 and the backup modem perform functions based on the corresponding setting mode. That is, when errors are happened in the primary modem 220, the primary modem 220 suspends the primary modem mode and is changed into the backup modem mode based on a control command from the control unit 250. At this time, the backup modem 221 is changed into the primary modem mode based on the control command from the control unit 250 and performs functions of the primary modem mode which are operated in the primary modem 220.

The first telecommand processing unit 210 uses the COP algorithm recommended in the CCSDS standard for ensuring the transmitting frame sequence of the telecommand transmitted from the satellite control center 100. That is, the first telecommand processing unit 210 connected with the primary modem 220 transmits the telecommand transmitted from the satellite control center 100 into the satellite 300 based on the COP algorithm and transmits the telemetry transmitted from the satellite 300 into the satellite control center 100.

Also, the first telecommand processing unit 210 checks the transmission state of the telecommand between modems, i.e., the primary modem 220 and the backup modem 221, and the satellite 300. That is, the first telecommand processing unit 210 examines a command link control word (CLCW) of the telemetry transmitted from the satellite 300 and checks whether or not the satellite 300 receives the telecommand normally. As mentioned above, when the satellite 300 receives the telecommand normally, the first telecommand processing unit 210 transmits a corresponding message “Positive Confirm” into the satellite control center 100. When the satellite 300 receives the telecommand abnormally, the first telecommand processing unit 210 transmits a corresponding message “Negative Confirm” and “Suspend Indication” or “Alert Indication” into the satellite control center 100.

At this time, when transmission of the telecommand into the satellite 300 is failed, the first telecommand processing unit 210 re-transmits the telecommand based on a re-transmission algorithm, e.g., Go-Back-N algorithm. When the telecommand re-transmission is not performed normally, the first telecommand processing unit 210 regards as that the satellite 300 receives the telecommand abnormally.

The primary modem 220 is connected between the first telecommand processing unit 210 and the switching unit 230.

The primary modem 220 converts a baseband signal used for transmitting the telecommand and receiving the telemetry transmitted from the satellite control center 100 into an intermediate frequency signal, e.g., 70 MHz, and transmits the intermediate frequency signal into the up/down frequency converting unit 240, or converts a received intermediate frequency signal from the up/down frequency converting unit 240 into a baseband signal and transmits the baseband signal into the satellite control center 100.

Since the second telecommand processing unit 211 and the backup modem 221 perform the same functions as the first telecommand processing unit 210 and the primary modem 220, and therefore, for easy description, detailed description on them will be omitted.

The switching unit 230 selectively setup a route of the telecommand between the primary modem 220 and the up/down frequency converting unit 240 and between the backup modem 221 and the up/down frequency converting unit 240 based on the control command of the control unit 250. That is, when the switching unit 230 sets the primary modem 220 as the route of the telecommand, the intermediate frequency signals of the primary modem 220 are inputted into the up/down frequency converting unit 240. Also, when the switching unit 230 sets the backup modem 221 as the route of the telecommand, intermediate frequency signals of the backup modem 221 are inputted into the up/down frequency converting unit 240.

Particularly, when the switching unit 230 sets the primary modem 220 as the route of the telecommand, although intermediate frequency signals of the backup modem 221 are transmitted into the switching unit 230, the intermediate frequency signals of the backup modem 221 are automatically terminated.

However, the switching unit 230 transmits the telemetry inputted from the up/down frequency converting unit 240 into the primary modem 220 and the backup modem 221. So the telemetry is transmitted without loss into the satellite control center 100 through the primary modem 220 and the backup modem 221.

Herein, the up/down frequency converting unit 240 includes an up-converting unit and a down-converting unit.

The up/down frequency converting unit 240 up-converts the intermediate frequency signals inputted from the primary modem 220 or the backup modem 221 through a transmission/reception link determined in the switching unit 230 into radio frequency signals and outputs the radio frequency signals through a transmitting antenna. Also, the up/down frequency converting unit 240 down-converts the radio frequency signals inputted from the transmitting antenna into the intermediate frequency signals and outputs the intermediate frequency signals into the switching unit 230.

The control unit 250 controls the first telecommand processing unit 210, the second telecommand processing unit 211, the primary modem 220, the backup modem 221, the switching unit 230 and the up/down frequency converting unit 240.

Moreover, the control unit 250 sets the route of telecommand of the switching unit 230 based on requests from the operator. That is, when the control unit 250 sets the route of telecommand between the primary modem 220 and the switching unit 230, the control unit 250 connects an output port of the telecommand of the primary modem 220 with the up/down frequency converting unit 240. Also, when the control unit 250 sets the route of telecommand between the backup modem 221 and the switching unit 230, the control unit 250 connects an output port of the telecommand of the backup modem 221 with the up/down frequency converting unit 240.

After the route of telecommand is decided, the control unit 250 observes state of the primary modem 220 and the backup modem 221 and gathers state information. Herein, the control unit 250 observes the state of the primary modem 220 and the backup modem 221 based on a polling method and gathers the state information in the same period.

More particularly, when the state of the primary modem 220 is normal, the control unit 250 confirms the state of the backup modem 221. Then, when the state of the backup modem 221 is normal, the control unit 250 continuously gathers and confirms the state information of the primary modem 220 and the backup modem 221. Then, when the state of the backup modem 221 is abnormal, the control unit 250 reports corresponding matters to the operator, e.g., alerting alarm and an examination request for the state of the backup modem 221, and continuously gathers the state information of the primary modem 220. If the state information of the primary modem 220 gathered in the control unit 250 is normal, the telecommand inputted from the satellite control center 100 can be transmitted into the satellite 300 through the primary modem 220 normally. Therefore, the telecommand can be transmitted although the backup modem 221 is abnormal.

On the other hand, when the state of the primary modem 220 is abnormal, the control unit 250 reports corresponding matters to the operator, e.g., alerting alarm and an examination request for the state of the primary modem 220, and confirms the state information of the backup modem 221. Then, when the backup modem 221 is normal, the control unit 250 changes the route of telecommand from the primary modem 220 into the backup modem 221 by controlling the switching unit 230. Also, the control unit 250 sets the backup modem 221 as a ‘primary modem mode’ and the primary modem 220 as a ‘backup modem mode’.

Meanwhile, when the backup modem 221 is abnormal, the control unit 250 reports occurrence of critical error to the operator and terminates a state observation of the backup modem 221.

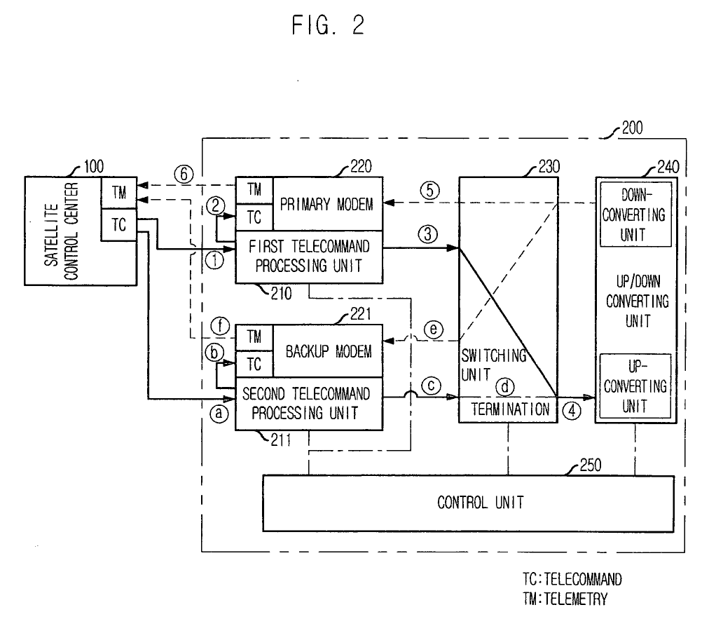

FIG. 2 is a diagram for illustrating a method for setting a route of telecommand in a duplex system in accordance with an embodiment of the present invention.

As shown, the first telecommand processing unit 210 and the second telecommand processing unit 211 of the duplex system in accordance with the present invention receive the same telecommand from the satellite control center 100 (\textcircled{1}, \textcircled{a}).

Then, the first telecommand processing unit 210 changes the telecommand into a predetermined format and transmits into the primary modem 220 (\textcircled{2}). Similarly, the second telecommand processing unit 211 changes the telecommand into the predetermined format and transmits into the backup modem 221 (\textcircled{b}).

Then, the primary modem 220 converts the baseband signal of the telecommand into the intermediate frequency signal and transmits into the switching unit 230 (\textcircled{3}). Similarly, the backup modem 221 converts the baseband signal of the telecommand into the intermediate frequency signal and transmits into the switching unit 230 (\textcircled{c}).

Next, the switching unit 230 transmits the intermediate frequency signal into the up/down frequency converting unit 240 selectively. Herein, when the route of telecommand decided as the primary modem 220, the switching unit 230 transmits the intermediate frequency signal inputted from the primary modem 220 into the up converting unit of the up/down frequency converting unit 240 (\textcircled{4}). Here, the intermediate frequency signal inputted from the backup modem 221 (\textcircled{d}) disappears in the switching unit 230.

However, when an error occurs in the primary modem 220, the switching unit 230 changes the route of telecommand into the backup modem 221 based on the control command of the control unit 250 and transmits the inputted intermediate frequency signal from the backup modem 221 into a up converting unit of the up/down frequency converting unit 240.

Then, a down converting unit of the up/down frequency converting unit 240 converts the telemetry transmitted from the satellite 300 into the intermediate frequency signal and transmits the intermediate frequency signal into the switching unit 230. Herein, the switching unit 230 transmits the telemetry into the primary modem 220 and the backup modem 221 (\textcircled{5}, \textcircled{e}).

Next, the primary modem 220 and the backup modem 221 transmit the telemetry into the satellite control center 100 (\textcircled{6}, \textcircled{f}).

As described above, as the switching unit 230 transmits the telemetry inputted from the up/down frequency converting unit 240 into the primary modem 220 and the backup modem 221, it is determined that the primary modem 220 and the backup modem 221 transmit the telecommand into the satellite 300 normally. That is, although the error occurs in the primary modem 220, the duplex system of the present invention changes the route of telecommand from the primary modem 220 into the backup modem 221 which performs the same operations as the primary modem 220. Therefore, seamless transmission of the telecommand can be transmitted into the satellite 300.

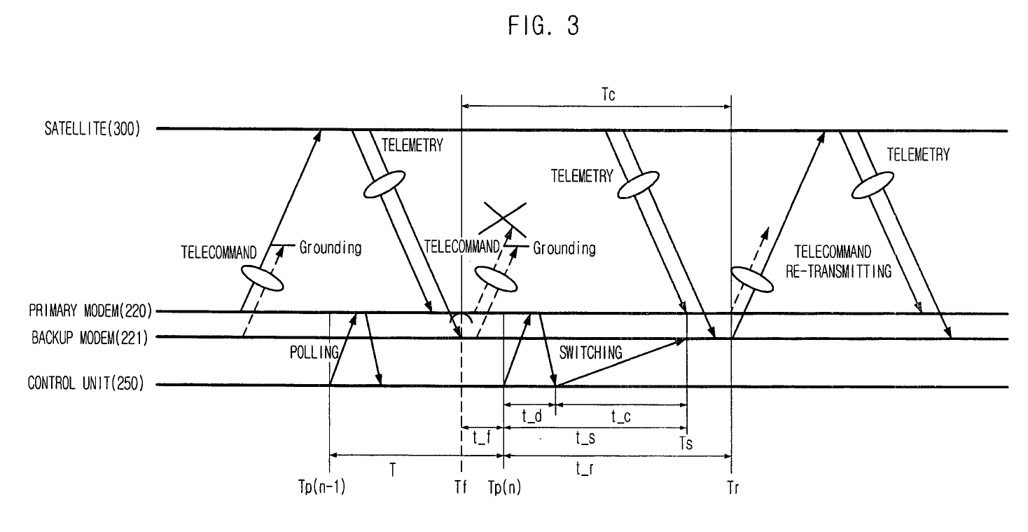

FIG. 3 is a diagram for illustrating a signal flow for resetting a route of telecommand into a backup modem by detecting an error in a primary modem in accordance with an embodiment of the present invention.

Each of parameters illustrated in FIG. 3 will be described in Table 1.

TABLE 1

| PARAMETER | DESCRIPTION |
|---|---|
| Ts | Time point after an error is detected, the route of |
| | the telecommand is completely changed by the |
| | switching unit 230. |
| Tr | Re-transmission time |
| T | Period of polling |
| t_c | Requirement time for switching |
| t_d | Requirement time for detecting the error of the |
| | primary modem 220 |
| t_s | Requirement time for switching after the state of |
| | modems 220 and 221 are confirmed based on polling. |
| Tp(n) | Polling time point of modems 220 and 221 in the |
| | control unit 250 |
| Tf | Error occurrence time point of modems 220 and 221 |
| t_f | Requirement time for observing states of modems 220 |
| | and 221 in the control unit 250 after error occurs. |
| Tc | Transmission period of telecommand frame |
| t_r | Requirement time for detecting the error of the |
| | primary modem 220, polling, switching and re- |
| | transmitting the telecommand frame. |

The parameters shown in Table 1 are satisfied with the following Eq. 1.

$$Tp ( n ) = Tp ( n - 1 ) + T \\ Tf > Tp ( n - 1 ) + t\_d \\ \begin{matrix}t\_f = Tp ( n ) - Tf = Tp ( n - 1 ) + T - Tf \\ = Tp ( n - 1 ) + T - Tp ( n - 1 ) - t\_d = T - t\_d\end{matrix} \qquad Eq . 1$$

Meanwhile, the control unit 250 sets Tc, which is the transmission period of the telecommand frame into the satellite 300, to be larger than a value obtained by summing t_f, which is the requirement time for observing states (polling) of the primary modems 220 and the backup modem 221 after the error occurs in the primary modem 220, and t_s, which is the requirement time for switching after the state of the primary modem 220 and the backup modem 221 are confirmed based on polling. That is, it is expressed by the following Eq. 2.

t_{—}f+t_{—}s<Tc Eq. 2

Also, t_s is expressed by the following Eq. 3.

t_{—}s=t_{—}d+t_{—}c Eq. 3

When Eqs. 1 and 3 are substituted into the Eq. 2, the following Eq. 4 is obtained.

T<Tc−t_{—}c Eq. 4

As the Eq. 4, the control unit 250 sets the period of polling T to be smaller than a value obtained by subtracting the requirement time for switching t_c from the transmission period of telecommand frame into the satellite 300 Tc. Namely, the control unit 250 sets t_d, which is the requirement time for detecting the error of the primary modem 220 and t_c, which is the requirement time for switching from the primary modem 220 into the backup modem 221 within the transmission period of telecommand frame Tc. That is, t_s (=t_d+t_c)<Tc.

As described above, the control unit 250 sets the period of polling for observing the state of the primary modem 220 and the backup modem 221. When the error occurs in the primary modem 220, the control unit 250 changes the route of telecommand into the backup modem 221. Therefore, re-transmission of the telecommand can be successfully performed.

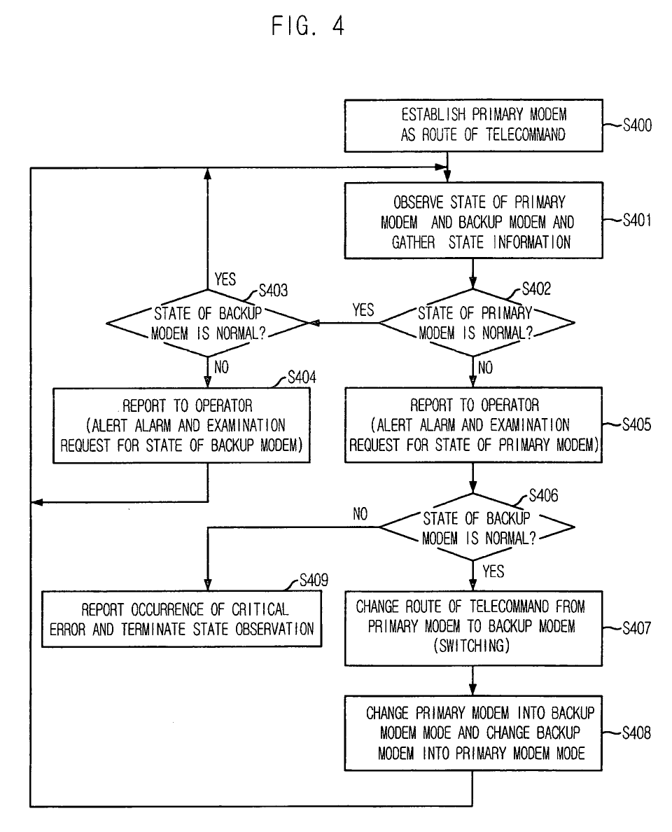

FIG. 4 is a flowchart for illustrating a method for setting a route of telecommand in accordance with an embodiment of the present invention.

As shown, the duplex system 200 of the present invention establishes the route of telecommand as the primary modem 220 by controlling the switching unit 230 at step S400.

Then, the duplex system 200 gathers the state information of the primary modem 220 and the backup modem 221 periodically in order to observe the state of the primary modem 220 and the backup modem 221 at step S401. Herein, the duplex system 200 observes the primary modem 220 and the backup modem 221 periodically based on the polling method.

Next, the duplex system 200 confirms the state of the primary modem 220 at step S402. When the state of the primary modem 220 is normal, the duplex system 200 confirms the state of the backup modem 221 at step S403. Here, when the state of the backup modem 221 is normal, the step S401 is repeated. However, when the state of the backup modem 221 is abnormal, the duplex system 200 reports the error to an operator at step S404. That is, the duplex system 200 provides the operator with alerting alarm and an examination request for the state of the backup modem 221.

On the other hand, when the primary modem 220 is abnormal at step S402, the duplex system 200 reports the error to the operator at step S405. That is, the duplex system 200 provides the operator with alerting alarm and an examination request for the state of the primary modem 220.

Next, when the primary modem 220 is abnormal, the duplex system 200 confirms the state of the backup modem 221 at step S406. When the backup modem 221 is normal, the duplex system 200 changes the route of telecommand from the primary modem 220 to the backup modem 221 at step S407. Then, the duplex system 200 changes the primary modem 220 into a ‘backup modem mode’ and the backup modem 221 into a ‘primary modem mode’ at step S408.

Meanwhile, when the backup modem 221 is abnormal, the duplex system 200 reports occurrence of a critical error and terminates the state observation at step S409.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

As describe above, the present invention can transmit the telecommand without resetting the new route of telecommand when an error occurs in the predetermined route of telecommand in order to ensure a stability and a reliability of transmitting the telecommand in a satellite control system.

In addition, the present invention can transmit the telecommand having the stability and the reliability when the satellite control system controls a plurality of satellites and contacts with the satellites in short time.

Finally, the present invention can transmit the telecommand into the satellite seamlessly and continuously by observing the state of the route of telecommand periodically.

The present application contains subject matter related to Korean patent application No. 2006-0074931, filed with the Korean Patent Office on Aug. 8, 2006, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A duplex system for setting a route of telecommand, comprising:
a first telecommand processing means and a second telecommand processing means for changing a format of a telecommand into a predetermined format;
an up/down converting means for up-converting the telecommand and for down-converting a telemetry;
a first modem means for modulating the telecommand inputted from the first telecommand processing means, and transmitting a first modulated telecommand;
a second modem means for modulating the telecommand inputted from the second telecommand processing means, and transmitting a second modulated telecommand;
a controlling means for setting the first modem means as the route of telecommand, observing the first modem means and the second modem means and changing the second modem means as the route of telecommand when an error occurs in the first modem means; and
a switching means for setting the route of telecommand as one of the first modem means and the second modem means based on a control command from the controlling means and transmitting the telecommand through the route the telecommand into the up/down converting means.

2. The duplex system as recited in claim 1, wherein the controlling means detects the error occurs in the first modem means within a transmission period of the telecommand and changes the route of telecommand from the first modem means to the second modem means.

3. The duplex system as recited in claim 1, wherein the controlling means observes the first modem means and the second modem means based on polling method.

4. The duplex system as recited in claim 1, wherein the switching means receives the same telecommand from the first modem means and the second modem means, and receives the telemetry corresponding to the telecommand from the up/down converting means and transmits the telemetry into the first modem means and the second modem means.

5. The duplex system as recited in claim 1, wherein the switching means transmits the telecommand from the first modem means into the up/down converting means and terminates the telecommand from the second modem means when the first modem means is setup as the route of telecommand.

6. A method for setting a route of telecommand, comprising the steps of:
a) when a first route is determined as the route of telecommand between the first route and a second route, observing states of the first route and the second route; and
b) when an error occurs in the first route and the second route is normal, detecting the error in the first route and changing the route of telecommand from the first route to the second route within a transmission period of the telecommand.

7. The method as recited in claim 6, wherein the step b) further includes the steps of:
b1) when the first route and the second route are normal, observing the state of the first route and the second route continuously; and
b2) when the first route is normal and the second route is abnormal, alerting alarm to an operator.

8. The method as recited in claim 6, wherein the step b) further includes the step of:
b3) when the error occurs in the first route and the second route is abnormal, alerting alarm to an operator and terminating state observation of the first route and the second route.
